(19) United States
(12) Patent Application Publication
(10) Pub. No.: US 2024/0421339 A1
(43) Pub. Date: Dec. 19, 2024

(54) Z-FOLD PRISMATIC BATTERY INTERLEAVE STACKER MACHINE

(71) Applicant: DWFritz Automation, LLC, Wilsonville, OR (US)

(72) Inventors: Derek Graham AQUI, Wilsonville, OR (US); Roy Daniel GAROUTTE, Wilsonville, OR (US); Shawn A. BOLING, Wilsonville, OR (US)

(21) Appl. No.: 18/702,427

(22) PCT Filed: Oct. 19, 2022
(86) PCT No.: PCT/US2022/078393

§ 371 Date: Apr. 18, 2024

Related U.S. Application Data
(60) Provisional application No. 63/262,744, filed on Oct. 19, 2021.

(51) Int. Cl. H01M 10/04

(52) U.S. Cl. CPC H01M 10/0404; H01M 10/0431

(57) ABSTRACT

Disclosed is a z-fold prismatic battery interleave stacker machine. In some embodiments, the machine includes a first vertical elevator stack for providing anode electrodes, a second vertical elevator stack for providing cathode electrodes, a centrally located elevator stack configured to lower a partly assembled z-fold stack during assembly, a first set of tandem end effectors for sequentially handling anode electrodes, and a second set of tandem end effectors for sequentially handling cathode electrodes.

### RELATED APPLICATION

This application claims priority benefit of U.S. Provisional Patent Application No. 63/262,744, filed Oct. 19, 2021, which is hereby incorporated by reference in its entirety.

### TECHNICAL FIELD

This disclosure generally relates to a z-fold prismatic battery interleave stacker machine and, in particular, to a stack machine having for, each type of electrode, multiple combined positive/negative pressure end effectors.

### BACKGROUND INFORMATION

Prismatic batteries are formed by interleaving alternate layers of cathodes, insulating separators, and anodes. Accordingly, to form a stack, the separator is a continuous layer that is folded back and forth (z-fold) between the alternating anode and cathode layers.

Previous attempts to develop z-fold prismatic battery interleave stacker machines have included pick-and-place devices. Patent Application Publication No. US2006/0051652 A1 of Samuels, for example, describes an interleave machine to form a stack. FIG. 1 of Samuels shows a first pick-up and place device for handling a stack of cathodes, a second pick-up and place device for handling a stack of anodes, and a centrally located elevator for interleaving a separator between alternating anode and cathode layers. In one embodiment, Samuels describes a Bernoulli pick-up and place device for handling the electrodes. A carriage facilitates horizontal movement of the pick-up and place devices. Another example is Korean Patent No. 101220981, which also describes a stacking device having a first vacuum transfer means for anodes and a second vacuum transfer means for cathodes. Each vacuum transfer means can pivot to fold the separator down onto the stack.

Conventional z-fold stacker mechanisms are limited in throughput by system architectures following a repeating place/clamp/fold sequence. With one transfer device per each electrode, these previous attempts included various clamping and retention techniques to hold the stack in place while another electrode is placed on top, which reduces throughput. Moreover, synchronization for each transfer device and a separator feed device has been challenging.

### BRIEF SUMMARY OF THE DISCLOSURE

Disclosed is a z-fold prismatic battery interleave stacker machine having a first set of tandem end effectors and a second set of tandem end effectors. Members of the first and second sets counter rotate and interleave to achieve significantly higher throughput.

In one aspect, a z-fold prismatic battery interleave stacker machine includes a centrally located elevator stack configured to lower a partly assembled z-fold stack during assembly, a first set of tandem end effectors for sequentially handling anode electrodes, the first set of tandem end effectors including a first end effector and a second end effector, the first and second end effectors configured to rotate in a first rotational direction for moving the anode electrodes from a first outer location to the centrally located elevator stack, a second set of tandem end effectors for sequentially handling cathode electrodes, the second set of tandem end effectors including a third end effector and a fourth end effector, the third and fourth end effectors configured to rotate in a second rotational direction for moving the cathode electrodes from a second outer location to the centrally located elevator stack, and the first end effector and the second end effector configured to form counter-rotating pairs with, respectively, the third end effector and the fourth end effector.

The battery interleave stacker machine may also include a cam drive to rotate the first set of tandem end effectors.

The battery interleave stacker machine may also include a cam drive to rotate the second set of tandem end effectors.

The battery interleave stacker machine may also include each end effector attached to a reciprocated crank-driven arm.

The battery interleave stacker machine may also include each end effector having a pneumatic port for applying a vacuum pressure to lift an electrode.

The battery interleave stacker machine may also include each end effector having a pneumatic port for applying a positive pressure to release an electrode.

The battery interleave stacker machine may also include a first vertical elevator stack for providing the anode electrodes.

The battery interleave stacker machine may also include a second vertical elevator stack for providing the cathode electrodes.

The battery interleave stacker machine may also include a feed roller configured to move on an arcuate path for guiding a continuous separator sheet against leading edges of each end effector and thereby providing dynamic folding in response to the first and second rotational directions.

The battery interleave stacker machine may also include each end effector configured to move horizontally from the centrally located elevator stack and toward an electrode pick-up location after depositing an electrode atop the centrally located elevator stack.

The battery interleave stacker machine may also include each end effector configured to apply positive pressure while moving horizontally.

In another aspect, a method, performed by a z-fold prismatic battery interleave stacker machine, of forming a stack entails: on a first lateral side of the z-fold prismatic battery interleave stacker machine, moving a first end effector carrying a first electrode from its pick-up position while simultaneously moving, under the first end effector, a second end effector that is empty from a centrally located elevator stack and concurrently on a second lateral side of the z-fold prismatic battery interleave stacker machine, moving a third end effector carrying a second electrode downward onto a section of separator and atop the centrally located elevator stack while the first end effector moves out of the way and while a fourth end effector applies a vacuum to pick up and move a third electrode, on the first lateral side of the z-fold prismatic battery interleave stacker machine, moving the first end effector carrying the first electrode downward onto another section of separator and atop the centrally located elevator stack while the third end effector moves out of the way and while the second end effector applies a vacuum to pick up and move a fourth electrode and concurrently on the second lateral side of the z-fold prismatic battery interleave stacker machine, moving a fourth end effector carrying the third electrode from its pick-up position while simultaneously moving, under the second end effector, the third end effector that is empty from a centrally located elevator stack, and repeating the moving of end effectors such that the first end effector and the second end effector form counter-rotating pairs with, respectively, the third end effector and the fourth end effector.

The method may also include the pick-up position of the first electrode being atop a stack of electrodes.

The method may also include the pick-up position of the third electrode being atop a stack of electrodes.

The method may also include moving the end effectors using rotating cam drives.

The method may also include moving the end effectors using a first arm for the first and second end effectors, and a second arm for the third and fourth end effectors.

Additional aspects and advantages will be apparent from the following detailed description of embodiments, which proceeds with reference to the accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a front elevation view of a z-fold prismatic battery interleave stacker machine, according to one embodiment, shown during a first portion of its sequence of operation.

FIG. 2 is a front elevation view of the z-fold prismatic battery interleave stacker machine of FIG. 1, shown during a second portion of its sequence of operation.

FIG. 3 is a front elevation view of the z-fold prismatic battery interleave stacker machine of FIG. 1, shown during a third portion of its sequence of operation.

FIG. 4 is a front elevation view of the z-fold prismatic battery interleave stacker machine of FIG. 1, shown during a fourth portion of its sequence of operation.

FIG. 5 is a front elevation view of a z-fold prismatic battery interleave stacker machine, according to another embodiment, shown during a first portion of its sequence of operation.

FIG. 6 is a front elevation view of the z-fold prismatic battery interleave stacker machine of FIG. 5, shown during a second portion of its sequence of operation.

FIG. 7 is a front elevation view of the z-fold prismatic battery interleave stacker machine of FIG. 5, shown during a third portion of its sequence of operation.

FIG. 8 is a front elevation view of the z-fold prismatic battery interleave stacker machine of FIG. 5, shown during a fourth portion of its sequence of operation.

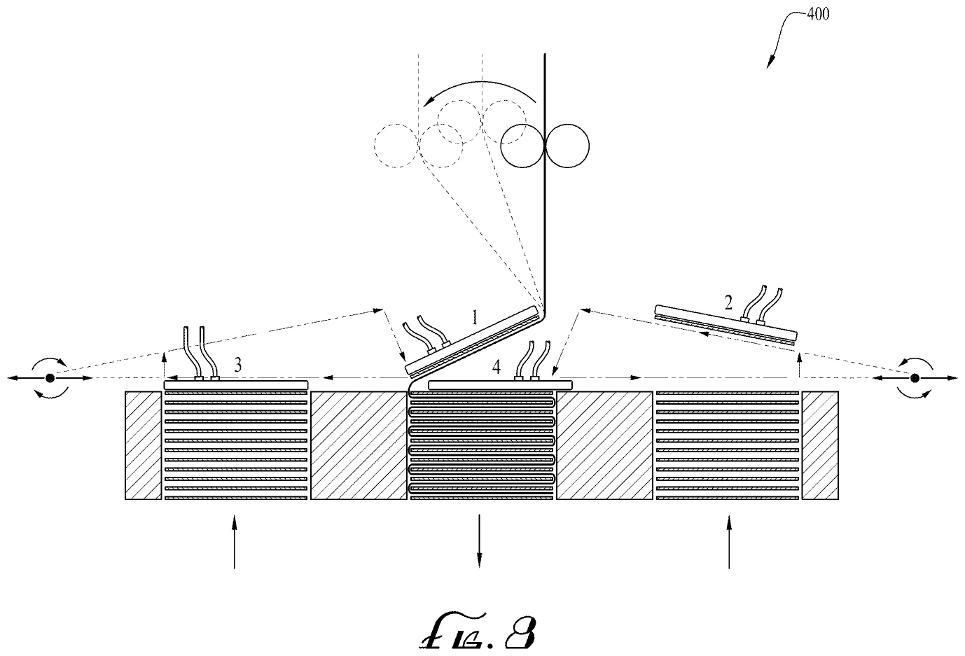

FIG. 9 is a flow chart of a process, in accordance with one embodiment.

### DETAILED DESCRIPTION OF EMBODIMENTS

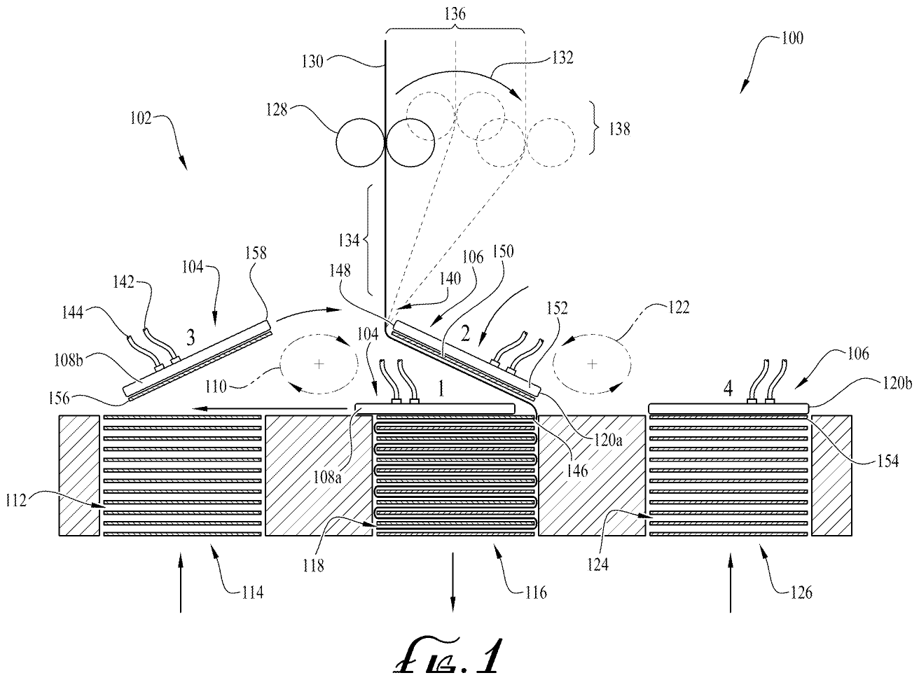

FIG. 1 shows a first position 100 in a sequence of assembly steps made possible by two counter-rotating sets of tandem end effectors in a z-fold prismatic battery interleave stacker machine 102. Before describing details of each position in the sequence, the following paragraphs provide an overview of components in, and associates functions of, z-fold prismatic battery interleave stacker machine 102.

As noted above, z-fold prismatic battery interleave stacker machine 102 includes a first set of tandem end effectors 104 and a second set of tandem end effectors 106. Each end effector acts as a gripping surface that uses pneumatic or electrostatic forces to carry electrodes.

First set of tandem end effectors 104 includes an end effector 108a and an end effector 108b, which rotate in a clockwise direction 110 for moving anode electrodes 112 from a first vertical elevator stack 114 to a centrally located elevator stack 116 that lowers a partly assembled z-fold stack 118 during assembly. In other embodiments, anode electrodes 112 may be provided by a conveyor instead of from first vertical elevator stack 114.

Similarly, second set of tandem end effectors 106 includes an end effector 120a and an end effector 120b, which rotate in a counterclockwise direction 122 for moving cathode electrodes 124 from a second vertical elevator stack 126 to centrally located elevator stack 116. In other embodiments, cathode electrodes 124 may be provided by a conveyor instead of from second vertical elevator stack 126.

First set of tandem end effectors 104 and second set of tandem end effectors 106 form counter-rotating pairs of end effectors, although other embodiments may include three or more end effectors for each type of electrode. Also, skilled persons will appreciate that the electrodes in first vertical elevator stack 114 and second vertical elevator stack 126 may be placed on opposites sides compared to the arrangement shown in the drawing figures.

As first set of tandem end effectors 104 and second set of tandem end effectors 106 rotate, a feed roller 128, through which a separator 130 is guided, reciprocates from side to side or moves along an arcuate path 132. A height 134 of separator 130 hanging from feed roller 128, a lateral travel distance 136 of lateral motion of feed roller 128, and a vertical travel distance 138 may be adjusted to facilitate dynamic folding 140 while still providing sufficient clearance for first set of tandem end effectors 104 and second set of tandem end effectors 106 to rotatably place electrodes.

To ensure synchronization between clockwise direction 110 rotation, counterclockwise direction 122 rotation, and back and forth motion of feed roller 128 along arcuate path 132, one or more cam drive shafts (not shown) are mechanically coupled. The one or more cam drive shafts ensure collision avoidance for end effectors while enabling controlled and synchronized high-speed sequential motion with each other and with feed roller 128. In other embodiments, the motion of a feed roller or end effectors is motion controlled by software to maintain synchronization.

Each end effector includes a vacuum source (not shown) and a pressure source (not shown) coupled to at least one pneumatic port. For example, end effector 108b includes a first supply line 142 and a second supply line 144. (For conciseness, reference numbers are omitted for supply lines of the other end effectors, which are functionally identical to end effector 108b.) In some embodiments, first supply line 142 is coupled to a vacuum source (not shown) affixed to or otherwise in fluid communication with first supply line 142. Likewise, second supply line 144 is coupled to a pressure source (not shown) affixed to or otherwise in fluid communication with second supply line 144.

Because pressure and vacuum pressures are separately actuated through individual lines, end effectors are capable of rapidly switching from negative to positive pressure applied to an electrode. Fast switching of vacuum end effectors to pressure mode enables sliding retraction. As shown in first position 100, the ability to rapidly change from negative to positive pressure is used in lieu of a separate restraint (i.e., clamp) on partly assembled z-fold stack 118. This is so because positive pressure from end effector 108a, for example, is sufficient to hold down a top electrode 146 in partly assembled z-fold stack 118 while end effector 108a laterally slides away from centrally located elevator stack 116.

First position 100 also shows that, while end effector 108a slides away, a leading edge 148 of end effector 120a engages separator 130 to create dynamic folding 140 while carrying a cathode electrode 150 that is on top of separator 130. End effector 120a is tilted so that its leading edge 148 is higher than its trailing edge 152. Because trailing edge 152 is lower, it is positioned to apply pressure to top electrode 146 while leading edge 148 is higher to provide space for end effector 108a to slide away horizontally (X). This interaction of alternating placement of electrodes facilitates continuous control (holding) of partly assembled z-fold stack 118. Moreover, place, hold, and fold functions are performed concurrently rather than sequentially.

First position 100 also shows how vacuum pressure is applied by end effector 120b to pick up a cathode electrode 154 from second vertical elevator stack 126 to initiate singulation with horizontal (X) motion. Such horizontal motion is also shown by end effector 108b carrying anode electrode 156 vertically (Z) while tilting its leading edge 158 to prepare for engaging separator 130 and make space for end effector 108a to lift another anode.

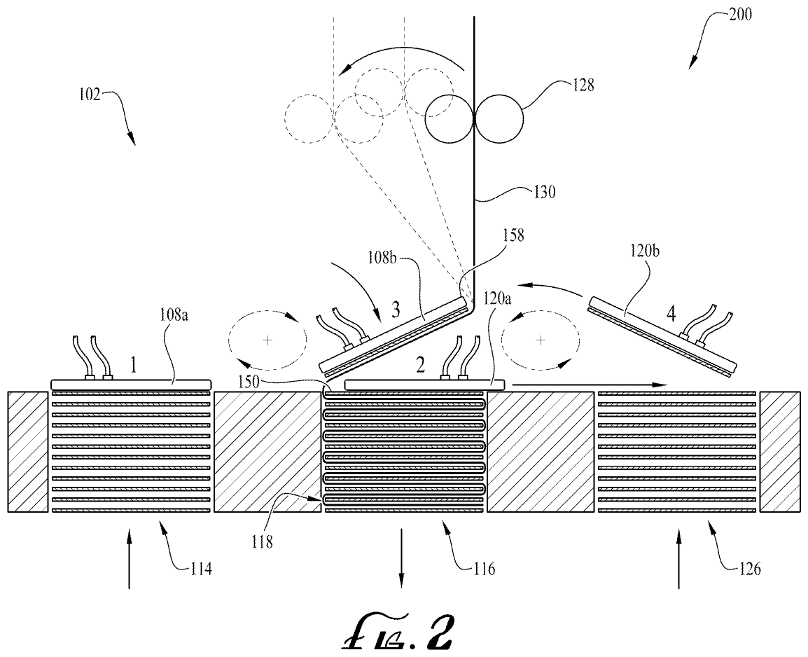

FIG. 2 shows a second position 200 in the sequence. In this position, end effector 108a has returned to first vertical elevator stack 114 to pick up another anode. End effector 120a has removed its tilt to complete placement of cathode electrode 150, which becomes top electrode 146 in partly assembled z-fold stack 118 while centrally located elevator stack 116 lowers to accommodate top electrode 146. Independent vertical elevators for electrodes and center stacks enable singulation and alignment, respectively.

Leading edge 158 of end effector 108b engages separator 130 to create dynamic folding 140, which is also facilitated by feed roller 128 that has moved laterally toward second vertical elevator stack 126. End effector 120b has lifted another cathode and tilted upwards.

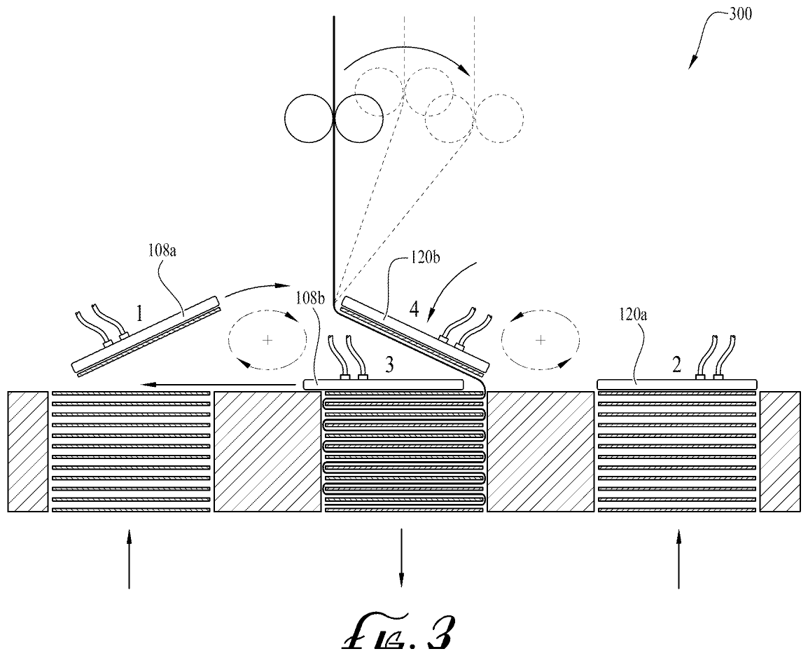

FIG. 3 shows a third position 300 in which end effector 108b has placed another anode in partly assembled z-fold stack 118 while end effector 120b begins to take its place. End effector 120a is picking up a cathode. End effector 108a is tilting upward.

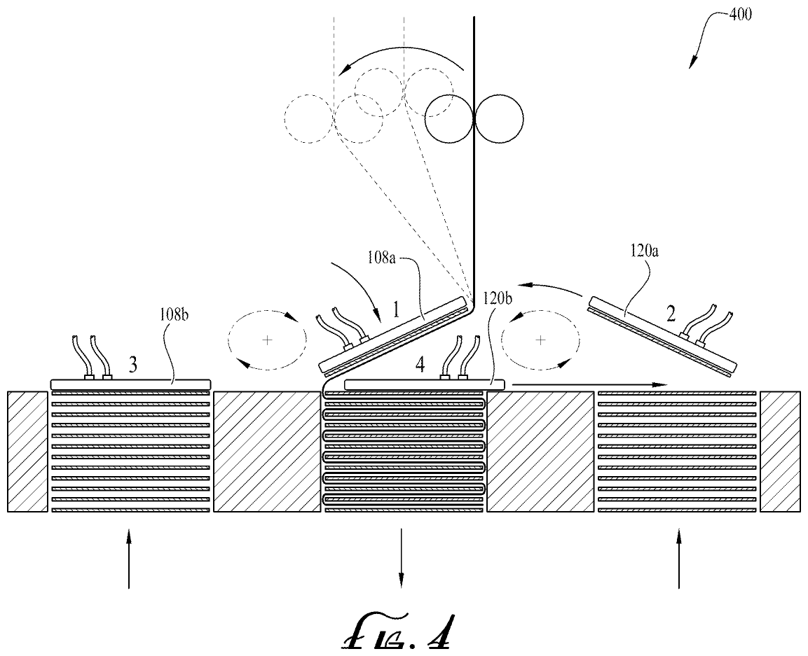

FIG. 4 shows a fourth position 400 in which end effector 120b has placed another cathode in partly assembled z-fold stack 118 while end effector 108a begins to take its place. End effector 108b is picking up an anode. End effector 120a is tilting upward.

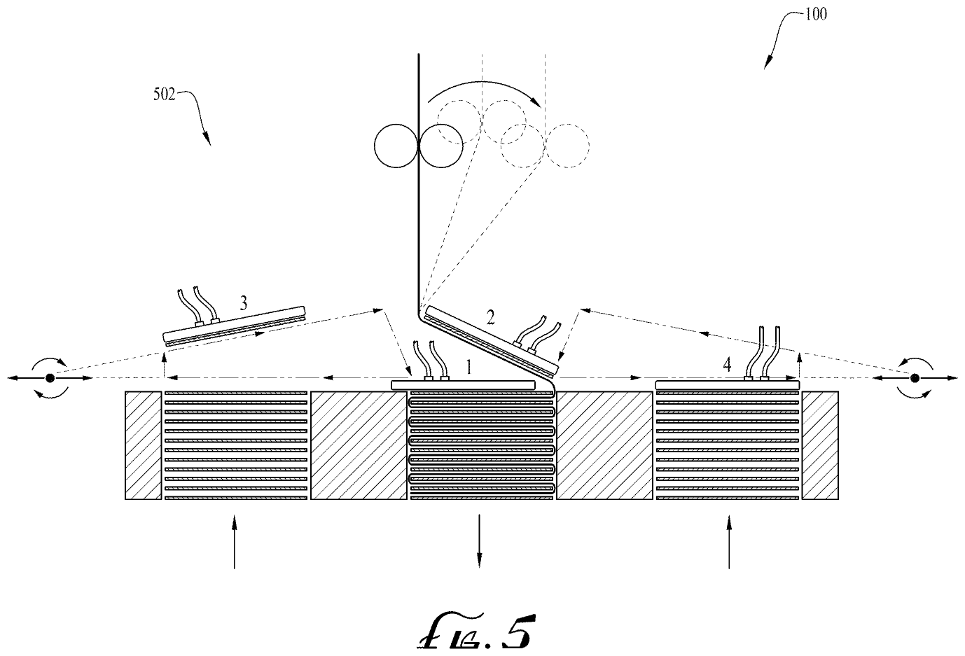

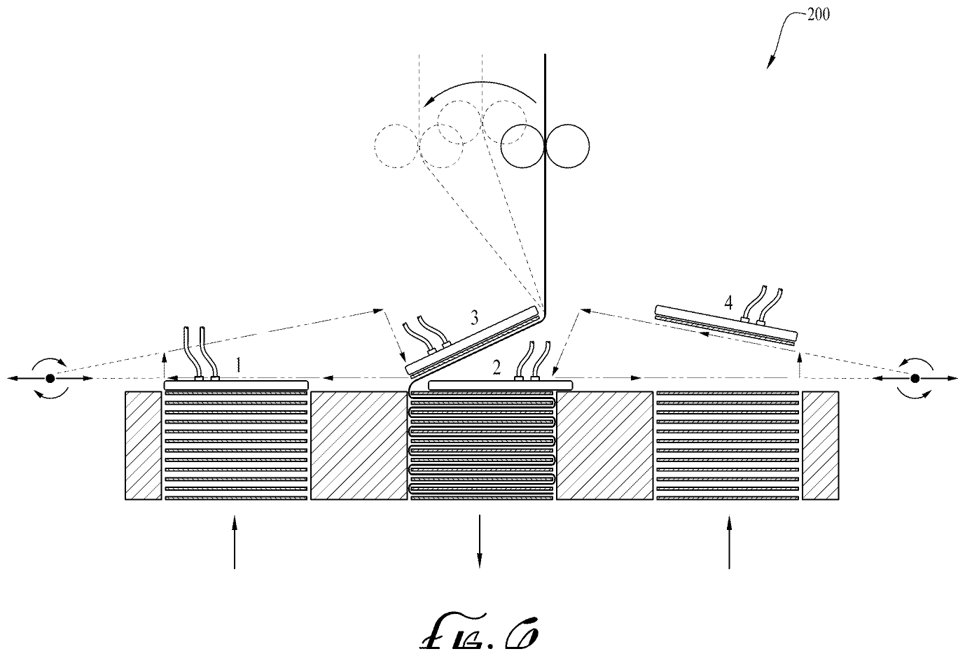

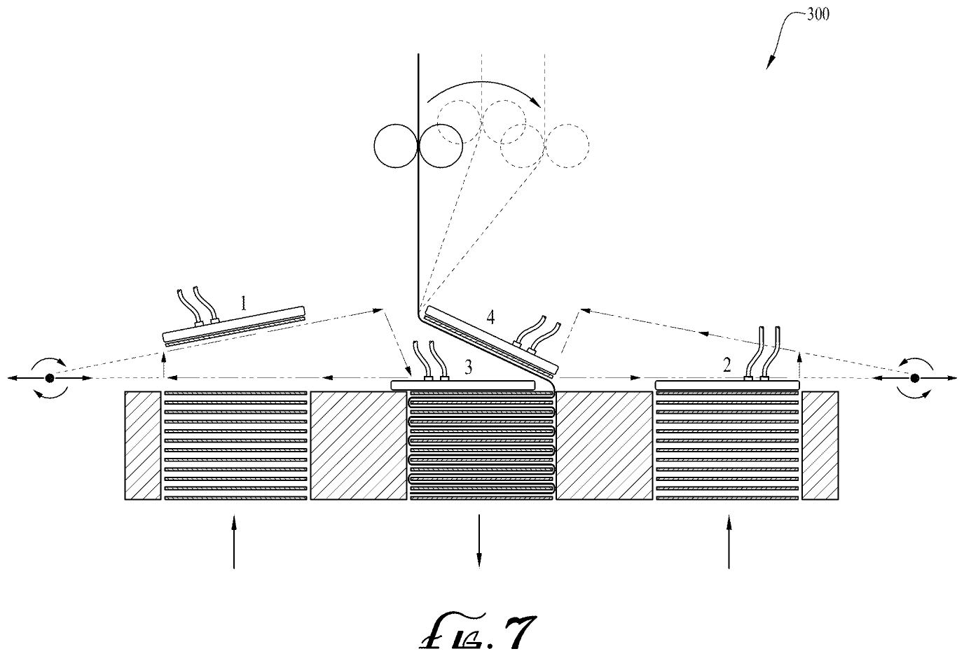

FIG. 5-FIG. 7 show the same sequence of positions as those shown in FIG. 1-FIG. 4, but in this example a z-fold prismatic battery interleave stacker machine 502 has each end effector attached to an arm that can pivot and slide. Along the middle of the arm, a track guides the motion to follow the circuits shown in broken arrow lines, with spring returns (not shown) for moving the end effector along the arced sections over the central stack. The opposite side of the arm is reciprocated (which itself can be crank driven) to achieve the desired motion of the end effector.

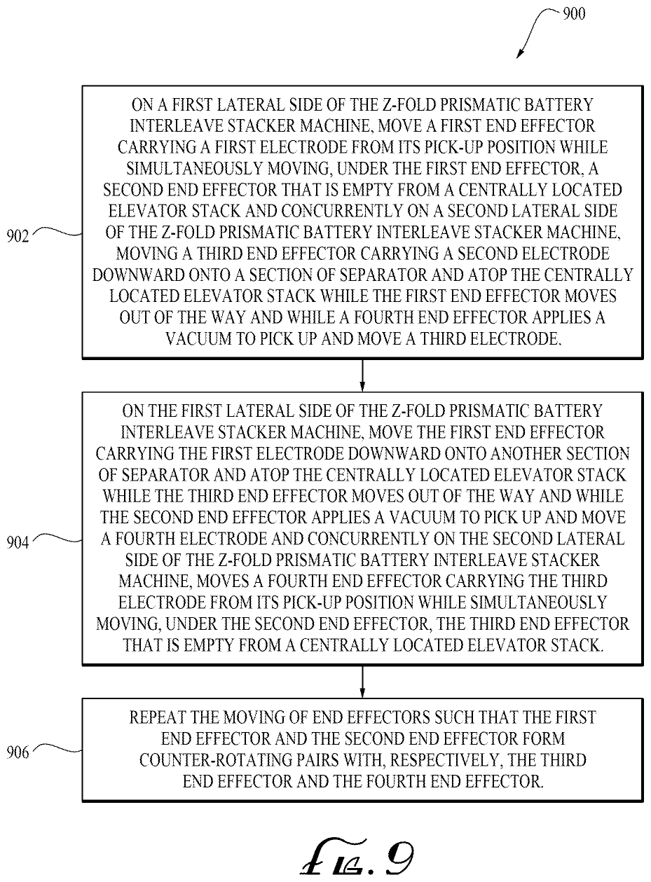

FIG. 9 shows a process 900, performed by a z-fold prismatic battery interleave stacker machine (such as machine 102 or 502), of forming a stack.

In block 902, process 900 on a first lateral side of the z-fold prismatic battery interleave stacker machine, moves a first end effector carrying a first electrode from its pick-up position while simultaneously moving, under the first end effector, a second end effector that is empty from a centrally located elevator stack and concurrently on a second lateral side of the z-fold prismatic battery interleave stacker machine, moving a third end effector carrying a second electrode downward onto a section of separator and atop the centrally located elevator stack while the first end effector moves out of the way and while a fourth end effector applies a vacuum to pick up and move a third electrode.

In block 904, process 900 on the first lateral side of the z-fold prismatic battery interleave stacker machine, moves the first end effector carrying the first electrode downward onto another section of separator and atop the centrally located elevator stack while the third end effector moves out of the way and while the second end effector applies a vacuum to pick up and move a fourth electrode and concurrently on the second lateral side of the z-fold prismatic battery interleave stacker machine, moves a fourth end effector carrying the third electrode from its pick-up position while simultaneously moving, under the second end effector, the third end effector that is empty from a centrally located elevator stack.

In block 906, process 900 repeats the moving of end effectors such that the first end effector and the second end effector form counter-rotating pairs with, respectively, the third end effector and the fourth end effector.

Skilled persons will appreciate that many changes may be made to the details of the above-described embodiments without departing from the underlying principles of the invention. For example, robot arms may be used instead of a cam drive. The scope of the present invention should, therefore, be determined only by claims and equivalents thereof.

1. A z-fold prismatic battery interleave stacker machine, comprising:
a centrally located elevator stack configured to lower a partly assembled z-fold stack during assembly;
a first set of tandem end effectors for sequentially handling anode electrodes, the first set of tandem end effectors including a first end effector and a second end effector, the first and second end effectors being configured to rotate in a first rotational direction for moving the anode electrodes from a first outer location to the centrally located elevator stack; and
a second set of tandem end effectors for sequentially handling cathode electrodes, the second set of tandem end effectors including a third end effector and a fourth end effector, the third and fourth end effectors being configured to rotate in a second rotational direction for moving the cathode electrodes from a second outer location to the centrally located elevator stack, wherein the first end effector and the second end effector are configured to form counter-rotating pairs with, respectively, the third end effector and the fourth end effector.

2. The battery interleave stacker machine of claim 1, further comprising a cam drive to rotate the first set of tandem end effectors.

3. The battery interleave stacker machine of claim 1, further comprising a cam drive to rotate the second set of tandem end effectors.

4. The battery interleave stacker machine of claim 1, in which each end effector is attached to a reciprocated crank-driven arm.

5. The battery interleave stacker machine of claim 1, in which each end effector includes a pneumatic port for applying a vacuum pressure to lift an electrode.

6. The battery interleave stacker machine of claim 1, in which each end effector includes a pneumatic port for applying a positive pressure to release an electrode.

7. The battery interleave stacker machine of claim 1, further comprising a first vertical elevator stack for providing the anode electrodes.

8. The battery interleave stacker machine of claim 1, further comprising a second vertical elevator stack for providing the cathode electrodes.

9. The battery interleave stacker machine of claim 1, further comprising a feed roller configured to move on an arcuate path for guiding a continuous separator sheet against leading edges of each end effector and thereby providing dynamic folding in response to the first and second rotational directions.

10. The battery interleave stacker machine of claim 1, in which each end effector is configured to move horizontally from the centrally located elevator stack and toward an electrode pick-up location after depositing an electrode atop the centrally located elevator stack.

11. The battery interleave stacker machine of claim 1, in which each end effector applies positive pressure while moving horizontally.

12. A method, performed by a z-fold prismatic battery interleave stacker machine, of forming a stack, the method comprising:
on a first lateral side of the z-fold prismatic battery interleave stacker machine, moving a first end effector carrying a first electrode from its pick-up position while simultaneously moving, under the first end effector, a second end effector that is empty from a centrally located elevator stack and concurrently on a second lateral side of the z-fold prismatic battery interleave stacker machine, moving a third end effector carrying a second electrode downward onto a section of separator and atop the centrally located elevator stack while the first end effector moves away and while a fourth end effector applies a vacuum to pick up and move a third electrode;
on the first lateral side of the z-fold prismatic battery interleave stacker machine, moving the first end effector carrying the first electrode downward onto another section of separator and atop the centrally located elevator stack while the third end effector moves away and while the second end effector applies a vacuum to pick up and move a fourth electrode and concurrently on the second lateral side of the z-fold prismatic battery interleave stacker machine, moving a fourth end effector carrying the third electrode from its pick-up position while simultaneously moving, under the second end effector, the third end effector that is empty from a centrally located elevator stack; and
repeating the moving of end effectors such that the first end effector and the second end effector form counter-rotating pairs with, respectively, the third end effector and the fourth end effector.

13. The method of claim 12, in which the pick-up position of the first electrode is atop a stack of electrodes.

14. The method of claim 12, in which the pick-up position of the third electrode is atop a stack of electrodes.

15. The method of claim 12, further comprising moving the end effectors using rotating cam drives.

16. The method of claim 12, further comprising moving the end effectors using a first arm for the first and second end effectors, and a second arm for the third and fourth end effectors.
